(19) United States
(12) Patent Application Publication
(10) Pub. No.: US 2020/0293671 A1
(43) Pub. Date: Sep. 17, 2020

(54) DEVICE AND METHOD FOR SECURE DATA BACKUP

(71) Applicant: HEWLETT PACKARD ENTERPRISE DEVELOPMENT LP, Houston, TX (US)

(72) Inventors: Michael R. Krause, Boulder Creek, CA (US); Melvin K. Benedict, Magnolia, TX (US)

(21) Appl. No.: 16/352,293

(22) Filed: Mar. 13, 2019

(51) Int. Cl. G06F 21/62; G06F 11/14; G06F 21/30; G06F 21/60; H04L 9/32

(52) U.S. Cl. CPC G06F 21/62; G06F 11/1464; H04L 9/3236; G06F 21/606; G06F 21/602; G06F 21/30

(57) ABSTRACT

A method as disclosed herein includes writing a data portion in a selected block of a primary medium. In some embodiments, the method includes determining a data authentication value for the selected block, identifying an emergency signal for the primary medium, and transferring the data portion and the data authentication value to a secondary medium when the emergency signal is asserted by a controller. In some embodiments, the method includes reading the data portion from the secondary medium, determining whether the data portion has been compromised in the secondary medium based on the data authentication value, and notifying a processor, with the controller, that the data portion has been compromised in the secondary medium.

### BACKGROUND

During emergency data backup, personal user information may be stored in a backup memory module. For example, when backing up a processor, a system may inadvertently dump in passwords, security keys, and access codes temporarily held in the processor cache to a backup memory module that may not have appropriate privacy and/or security protection. This may open up a system to malicious attacks simply by prompting emergency events that may trigger the transfer of personal user information to an unsecure, non-volatile data storage.

### BRIEF DESCRIPTION OF THE DRAWINGS

The accompanying drawings, which are included to provide further understanding and are incorporated in and constitute a part of this specification, illustrate disclosed embodiments and together with the description, serve to explain the principles of the disclosed embodiments. In the drawings:

FIG. 1 illustrates a system including multiple modules wherein a secondary medium is configured for emergency backup storage of at least one primary medium in a separate module, according to some embodiments.

FIG. 2A illustrates a diagram of a primary medium with multiple blocks and the corresponding data authentication values, according to some embodiments.

FIG. 2B illustrates a diagram of a secondary medium with multiple blocks transferred from the primary medium for backup storage, and the corresponding data authentication values, according to some embodiments.

FIG. 3 illustrates a data restore from the secondary medium to the primary medium using the data authentication values after an emergency backup event, according to some embodiments.

FIG. 4 is a flow chart illustrating steps in a method for performing an emergency backup of a primary medium into a secondary medium for storage, according to some embodiments.

FIG. 5 is a block diagram illustrating a system configured to perform methods as disclosed herein.

In the figures, elements and steps denoted by the same or similar reference numerals are associated with the same or similar elements and steps, unless indicated otherwise.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

The present disclosure is directed to emergency backup management of computer data stored in volatile memory. More generally, emergency backup strategies as disclosed herein may include any data processing devices that contain a memory media, such as a graphic processing unit (GPU) or general-purpose GPU (GPGPU), a field-programmable gate array (FPGA), a digital signal processor (DSP), and the like. In some embodiments, techniques and systems as disclosed herein may be applied to data stored in non-volatile media for checking point-to-point data to a second storage module (e.g., to reduce single-point-of-failure issues). Accordingly, the present disclosure is related to secure strategies for emergency data backup from one or more modules to a secondary module, comparing data authentication values stored in the backup module with a data authentication value calculated by a module controller.

Embodiments as disclosed herein use strategies such as checksum or cryptographically-secured hash functions to ensure primary medium image data integrity when copied to the secondary media, for backup. The secondary medium may be co-located with the primary medium or in a separate medium module. Some embodiments include architectures that support encrypting a primary medium image similar to what DDR-based backup solutions support. In embodiments as disclosed herein, upon retrieval of the backed up data from the secondary medium (e.g., after the emergency backup event), a primary controller takes steps to detect if the primary medium data was not corrupted or tampered with once copied to the secondary media.

### General Overview

In one embodiment of the present disclosure, a computer-implemented method as disclosed herein includes writing a data portion in a selected block of a primary medium and determining a data authentication value for the selected block. The computer-implemented method also includes identifying an emergency signal for the primary medium and transferring the data portion and the data authentication value to a secondary medium when the emergency signal is asserted by a controller. The computer-implemented method also includes reading the data portion from the secondary medium determining whether the data portion has been compromised in the secondary medium based on the data authentication value, and notifying a processor, with the controller, that the data portion has been compromised in the secondary medium.

According to one embodiment, a system is described that includes a power source, a backup storage, and a first module. The first module includes a controller, coupled to a primary medium including data provided by a data processing circuit. The controller is configured to select a block of the primary medium that includes a data portion, determine a data authentication value for the block, and identify an emergency signal for the primary medium. The controller is also configured to assert the emergency signal, transfer the data portion and the data authentication value to a secondary medium, and read the data portion from the secondary medium. The controller is also configured to determine whether the data portion has been compromised in the secondary medium based on the data authentication value, and to notify a processor that the data portion has been compromised in the secondary medium.

According to one embodiment, a device as disclosed herein includes a controller, coupled to a primary medium and a secondary medium. The controller is configured to partition the primary medium into multiple blocks, select a block from the multiple blocks that includes a data portion, and determine a data authentication value for the block. The controller is also configured to identify an emergency signal for the primary medium, assert the emergency signal, and transfer the data portion and the data authentication value to the secondary medium. The controller is also configured to read the data portion from the secondary medium, determine whether the data portion has been compromised in the secondary medium, based on the data authentication value, and notify a processor that the data portion has been compromised in the secondary medium.

In yet other embodiment, a system is described that includes a means for storing commands and a means for executing the commands causing the system to perform a method that includes writing a data portion in a selected block of a primary medium and determining a data authentication value for the selected block. The method also includes identifying an emergency signal for the primary medium and transferring the data portion and the data authentication value to a secondary medium when the emergency signal is asserted by a controller. The method also includes reading the data portion from the secondary medium, determining whether the data portion has been compromised in the secondary medium based on the data authentication value, and notifying a processor, with the controller, that the data portion has been compromised in the secondary medium.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### Example System Architecture

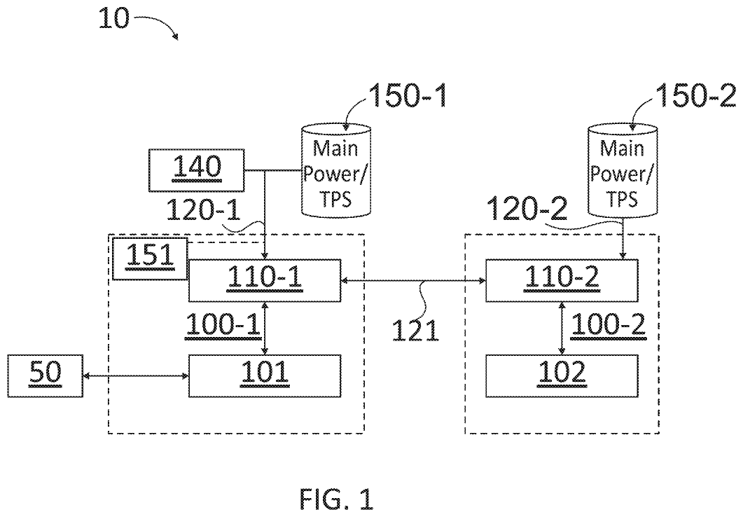

FIG. 1 illustrates a system 10, including multiple modules 100-1 and 100-2 (collectively referred to, hereinafter, as “modules 100”) wherein a secondary medium 102 is configured for emergency backup storage of at least one primary medium 101 in a separate module, according to some embodiments. First module 100-1 includes primary medium 101 and a primary controller 110-1. Second module 100-2 includes secondary medium 102 and a secondary controller 110-2. Hereinafter, primary controller 110-1 and secondary controller 110-2 will be collectively referred to as “controllers 110.” In some embodiments, secondary medium 102 is co-located with primary medium 101, and only one media controller 110 may be used. Accordingly, in some embodiments, the functionality of primary medium 101 and of secondary medium 102 may be implemented in the same device (e.g., a single “controller 110”). System 10 includes a processor 50 that provides data to primary medium 101. In some embodiments, first module 100-1 is configured to communicate with second module 100-2 via a point-to-point communication link 121. In some embodiments, communication link 121 enables a direct data transfer between modules 100 upon receipt, at primary controller 110-1, of emergency backup signal 140. For example, in some embodiments, link 121 may be configured in a point-to-point (P2P) topology and use the P2P protocols to exchange data. A tethered power source (TPS) 150-1 may be coupled to module 100-1 to provide emergency power to primary medium 101, to controller 110-1, or to the entire module 100-1, in case of a power failure or other emergency event (e.g., reset, shutdown, and the like). In some embodiments, emergency power may be provided by a local power source (LPS) 151, within module 100-1. In that regard, emergency backup signal 140 and TPS 150-1 (or LPS 151) may be provided to primary controller 110-1 through a single-wire protocol via interface 120-1. Likewise, TPS 150-2 may be coupled to secondary controller 110-2 via interface 120-2.

In some embodiments, first module 100-1 is configured in a point-to-point communication link 121 with second module 100-2. Each one of modules 100 may use a separate TPS 150-1 and 150-2 (hereinafter, collectively referred to as “TPS 150”), respectively. In some embodiments, two or more modules 100 may share a single TPS 150. Accordingly, each of modules 100 may be configured to separately monitor the status of TPS 150.

In some embodiments, to reduce cost, a shared TPS 150 may be desirable (e.g., LPS 151 may be costly and difficult to install in modules 100). In some embodiments, shared TPS 150 may include an uninterruptible power supply (UPS) provisioned within an enclosure (e.g., within one of modules 100, or in a separate enclosure) to provide emergency backup power for one or more modules 100 in the event of main power loss or instability through the main power pins of one or more modules 100.

In embodiments where module 100-1 is not co-located with module 100-2, then primary controller 110-1 in module 100-1 may support the following operations: BACKUP, to transfer data from primary medium 101 to secondary medium 102; RESTORE, to restore data from the secondary medium back to primary medium 101 (e.g., from secondary medium 102); ARM, to re-enable a BACKUP operation when the system is fully operational; and FACTORY DEFAULT to restore a state of primary medium 101 to a factory value, among other operations on primary medium 101. In the case of a BACKUP operation, primary controller 110-1 may initiate a peer to peer operation with secondary controller 110-2. Accordingly, communication link 121 may include a peer to peer communication path including, but not limited to, double-data rate (DDR) links including a master-slave configuration in addition to peer to peer, peripheral component interconnect (PCI-e), Gen-z, and the like. In some embodiments, a RESTORE operation may occur during initialization of primary controller 110-1. For example, controller 110-1 may discover a valid image of a system state on secondary medium 102, accordingly, controller may then initiate a peer to peer move of the data to primary medium 101 and perform an authentication operation of the restored data. In some embodiments; the authentication can take place prior to the RESTORE operation. In some embodiments, an ARM operation includes setting the components to perform (e.g., automatically) an emergency backup upon detecting a configured issue or state transition. Management is responsible for ensuring that secondary medium 102 is configured and ready to receive a backup image of primary medium 101. Accordingly, secondary medium 102 and secondary controller 110-2 may be operational, but without explicit knowledge that primary medium 101 is ARMed for emergency backup.

In some embodiments, ERASE and FACTORY DEFAULT are security features used, e.g., during decommission to remove all valid user data and configuration information. Likewise, secondary controller 110-2 in module 100-2 may support ERASE and FACTORY DEFAULT operations on secondary medium 102. In some embodiments, ERASE includes removing an image of primary medium 101 at the secondary medium 102. ERASE has no impact on the operation of primary medium 101, or its ability to perform an emergency backup (assuming there is sufficient storage to hold multiple images). When there is no sufficient storage, an ERASE operation may be performed prior to ARMing the primary medium 101 (e.g., via primary controller 110-1).

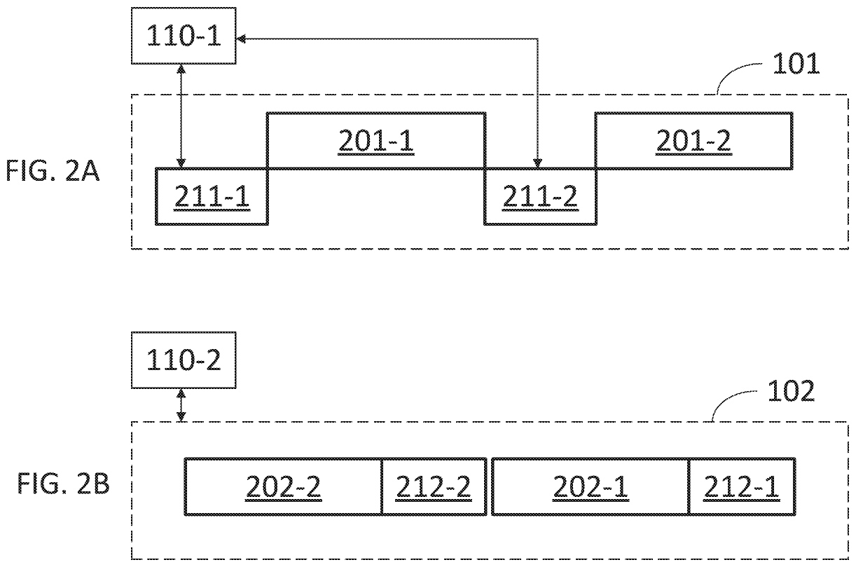

FIG. 2A illustrates a diagram of primary medium 101 with multiple blocks 201-1 and 201-2 (hereinafter, collectively referred to as “primary blocks 201”), and the corresponding data authentication values 211-1 and 211-2 (hereinafter, collectively referred to as “DA values 211”), according to some embodiments. In some embodiments, controller 110-1 divides primary medium 101 into 2^{DA-Range} byte blocks/subranges, of which the two primary blocks 201 are shown in the figure. Data authentication range (DA-Range) can be defined as the number of bytes a particular user, application, and the like, desires to make non-volatile data quickly recoverable after a catastrophic event. In some embodiments, DA-Range is a programmable (configurable) value (e.g., via primary controller 110-1). For each of primary blocks 201, primary controller 110-1 calculates DA values 211-1 and 211-2 of size 2^{DA-Range} bytes. DA-Range can be any length required to hold the security/data integrity information. For example, when a hash standard such as SHA3-384 is used, then at least 384 bits of information may be transferred. Further, the DA values 211 could contain a security identifier to enable primary controller 110-1 locate the corresponding security keys, certificates, and the like.

DA values 211 may include a specific checksum from the primary controller (e.g., a checksum or hash of the block or sub-block of data in primary blocks 201), or a cryptographically-secured hash. In some embodiments, at least one of DA values 211 may include a local cryptographic key used to encrypt data in blocks 201. This configuration would provide a self-checking process. In some embodiments, the key or hash data may be stored locally, e.g., in a trusted platform module (TPM). Hence, the key or hash is not exposed outside the primary controller. In some embodiments the key or hash data may be stored securely on a medium accessible to primary controller 110-1 (e.g., the primary medium, or another storage medium). In some embodiments, private encryption keys and private certificates may be stored in software unreadable storage accessible through primary media controller 110-1. Public keys and public certificates may be stored in software readable storage accessible through primary media controller 110-1. Private keys can be dynamically generated by primary media controller 110-1 or loaded through a secured protocol. In some embodiments, public keys are stored in a key distribution server (KDS) to enable third-party access. Accordingly, primary controller 110-1 has the authority, knowledge and control to keep encryption keys private, or public, or to interact with a KDS to simplify management at any scale.

In some embodiments, at least one of DA values 211 includes a separate encrypted authentication field or hash of the data (e.g., in addition to the hash mentioned earlier) such as error correction code (ECC) or block ECC characters, or a cyclic redundancy check (CRC). There are multiple cryptographically-secured hash standards that can be used to create DA values 211, e.g., SHA-224, SHA-256, SHA-384, SHA-512, SHA-512/224, SHA-512/256, SHA3-224, SHA3-384, and SHA3-512 are specified by Gen-Z. A solution may use simple end-to-end data integrity, e.g., T10 DIF/PI which use 64 b fields of which a 16 b CRC is calculated per block. While in some embodiments, ECC is used in the context of primary medium being a DRAM. However, some embodiments may use any of multiple of error detection and correction codes used in different technologies, e.g., forward error correction (FEC) as used in serial attached SCSI (SAS) and Ethernet, wherein data is authenticated as it moves across a wire to detect and correct multi-bit errors. DA block 201 can be recovered/processed with any type of ECC that enables data corruption or tampering to be detected. A cryptographically secured hash can detect corruption and tampering, and DA value 211 may include an ECC placed ahead of the hash to enable primary controller 110-1 to correct errors assuming that it did not conclude that the data had been tampered, in which case the protocol may be different (dump the data, quarantine, and the like). The use of a CRC or hash and/or encryption is determined by primary controller 110-1. When a CRC or hash is used, then DA block 201 may be written to secondary medium 102 including calculated results (e.g., DA values 212). When encryption is used in addition to a CRC or hash, then primary controller 110-1 may include additional information in each DA value 211, or it could include such information in an image header. Primary controller 110-1 contains the information as to what has been done with data blocks 201 during the backup or restore operation, and shares this information with secondary controller 110-2 or any other components at its own discretion.

When data privacy is desired, then primary controller 110-1 may encrypt the data using a key that is specific to primary controller 110-1. Accordingly, primary controller 110-1 may be able to retrieve the key for DA values 211. In some embodiments, the key for DA values 211 is retrieved from a secure local storage accessible to primary controller 110-1 (e.g., TPM and the like). For example, at a time when the data in blocks 201 is retrieved from secondary medium 102, after an emergency backup event. In some embodiments, primary controller 110-1 includes a strong packet authentication protocol to DA values 211, for enhanced security. Packet authentication protocols as disclosed herein may include anyone of several documented protocol using symmetric or asymmetric encryption key, e.g., a keyed-hash message authentication code (HMAC), non-malleable codes and the like. Accordingly, in embodiments where DA values 211 include an HMAC field (and, optionally, an anti-replay tag), primary controller 110-1 may detect whether data in blocks 202 is modified by error or by ill intent.

FIG. 2B illustrates a diagram of secondary medium 102 with multiple blocks 202-1 and 202-2 (hereinafter, collectively referred to as “secondary blocks 202”), transferred from primary medium 101 for backup storage, and the corresponding data authentication values 212-1 and 212-2 (hereinafter, collectively referred to as “authentication values 212”), according to some embodiments. For each of primary blocks 201 (or subranges of blocks 201), primary controller 110-1 initiates a sequence of write instructions onto secondary medium 102 via secondary controller 110-2. Accordingly, the write instructions from primary controller 110-1 may include instructions to write a first block (e.g., block 201-1) and its corresponding DA value (e.g., DA value 211-1) to secondary medium 102. Upon writing, block 201-1 is stored in secondary medium 102 as block 202-1. Likewise, block 201-2 from primary medium 101 is stored in secondary medium 102 as block 202-2. Further, DA values 211-1 and 211-2 are stored in secondary medium 102 as DA values 212-1 and 212-2. In some embodiments, secondary controller 110-2 ensures that, regardless of the relative location between blocks 202 in secondary medium 102, DA values 212 are contiguous to their respective blocks 202, thus avoiding a secondary record and associated pointer which could be intercepted.

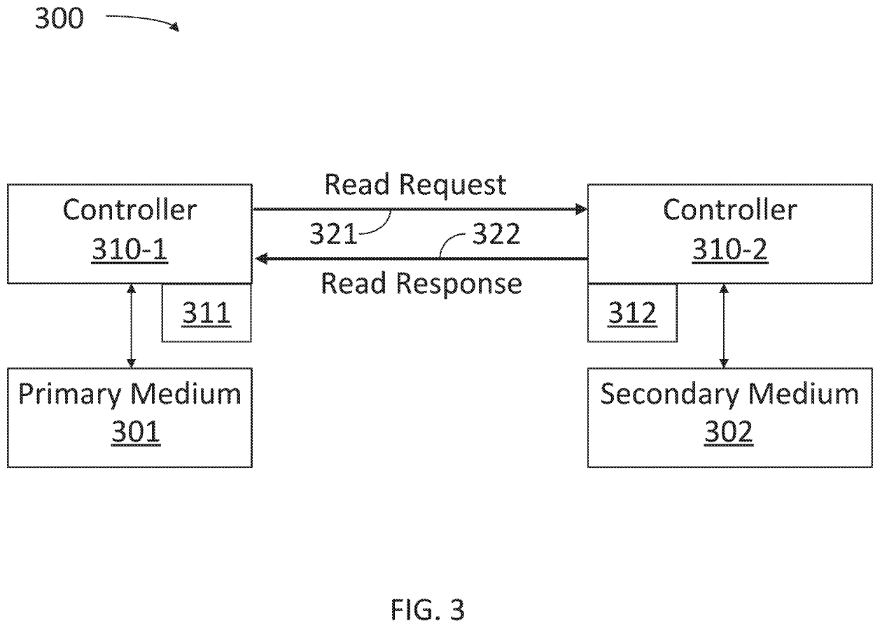

FIG. 3 illustrates a data restore in a system 300 from a secondary medium 302 to a primary medium 301 using the data authentication values after an emergency backup event, according to some embodiments. Accordingly, primary controller 310-1 issues a read request 321 to secondary controller 310-2. The read request includes a read request for data in the data block and for the DA authentication value. Secondary controller 310-2 then issues a read response 322 to primary controller 310-1. Read response 322 may include the data authentication values stored in secondary medium 302, for verification by primary controller 310-1. In some embodiments, read response 322 may also include the data stored in the corresponding blocks in second medium storage. In some embodiments, secondary controller 310-2 may wait before transferring the data from secondary medium 302 until receiving a confirmation from primary controller 310-1 that the data authentication value provided by secondary medium 302 is valid.

To restore primary medium 301 to its original state (e.g., after an emergency backup event), primary controller 310-1 may perform a checksum or a secure hash protocol. The key for the checksum or hash protocol may be retained as an entry in a primary medium platform (e.g., controller 110, or a Trusted Platform Module (TPM)). Hence, the key to the checksum or hash remains local and secure on the primary medium platform (e.g., within module 100-1). In addition, the key for the checksum or hash protocol may be stored in a third party secure storage separate from module 100-1, if desirable. This configuration may be desirable when a fatal issue requires the complete replacement of the local media platform (e.g., controller 310, or primary medium 301. In some embodiments, the key for the checksum and/or hash algorithm may be unique to controller 310-1. Accordingly, the key for the checksum and/or hash algorithm may not be observable on interface/fabric between primary medium 301 and secondary medium 302. For each stored block (e.g., blocks 202), primary controller 310-1 initiates a sequence of reads to secondary medium 302, via secondary controller 310-2. As each read response is executed, primary controller 310-1 calculates a DA value 311. When a block in secondary medium 302 is encrypted (e.g., an encrypted block 202), then primary controller 310-1 decrypts the block with DA value 311.

Primary controller 310-1 also reads a DA value 312 stored in secondary medium 302, and then compares it to DA value 311. DA value 312 is the value stored in secondary medium 302 upon backup from a DA value originally stored in primary medium 301. When the data in secondary medium 302 has been tampered with, accessed by a third party, or otherwise corrupted, DA value 312 and calculated DA value 311 will not match. Accordingly, a third party tampering with the data may overwrite the DA value 312 with the correct checksum (e.g., data DA 311) only if the attacker had the original hash or key. Otherwise, it would be extremely difficult or nearly impossible for the third party know how to alter DA value 312 to match calculated DA value 311. When DA value 312 and DA value 311 match, then the data has not been corrupted or tampered with within the secondary medium module. When primary controller 310-1 determines that the data was corrupted or tampered with during storage in secondary medium 302, then primary controller 310-1 initiates error handling and recovery. In some embodiments, the primary controller notifies a processor managing primary medium 301, or a baseboard manager controller (BMC) handling controller 310-1 and primary medium 301, that the data was corrupted in secondary medium 302. In general, when tampering is detected, the user may determine an appropriate policy. This may include notifying the baseboard management controller (BMC, for logging purposes), the operating system (OS) or the application.

Primary controller 310-1 verifies that DA value 312 is correct for the corresponding block as it reads the data back from secondary medium 302 and applies the data integrity/security algorithm to dynamically calculate the value that is then compared to the read DA value 312. To simplify management, in some embodiments primary media controller 310-1 writes an image header (e.g., metadata) at the head of a data block transferred to secondary medium 302. A metadata image example is included in Table I to illustrate how this can be done. Other technologies specify conceptually similar image headers.

TABLE I
(Exemplary metadata header of a data block transferred from a primary medium
to a secondary medium upon assertion of an emergency backup signal)

| | | | | | | | | |
|---|---|---|---|---|---|---|---|---|
| +7 | +6 | +5 | +4 | +3 | +2 | +1 | +0 | |
| 7\|6\|5\|4\| | 7\|6\|5\|4\| | 7\|6\|5\|4\| | 7\|6\|5\|4\| | 7\|6\|5\|4\| | 7\|6\|5\|4\| | 7\|6\|5\|4\| | 7\|6\|5\|4\| | |
| 3\|2\|1\|0 | 3\|2\|1\|0 | 3\|2\|1\|0 | 3\|2\|1\|0 | 3\|2\|1\|0 | 3\|2\|1\|0 | 3\|2\|1\|0 | 3\|2\|1\|0 | Byte |

| HEADER-FORMAT-UUID [63:0] | | | | 0x0 |
|---|---|---|---|---|
| HEADER-FORMAT-UUID [127:64] | | | | 0x8 |
| C-UUID [63:0] | | | | 0x10 |
| C-UUID [127:64] | | | | 0x18 |
| IMAGE-UUID [63:0] | | | | 0x20 |
| IMAGE-UUID [127:64] | | | | 0x28 |
| AUTHENTICATION-UUID [63:0] | | | | 0x30 |
| AUTHENTICATION-UUID [127:64] | | | | 0x38 |
| IMAGE LENGTH | | | | 0x40 |
| EK-SZ | HD-SZ | IMAGE SUB-VERSION | IMAGE VERSION | 0x48 |
| CHECKSUM | RO | NAME-SZ | VDEF-SZ | 0x50 |

| | |
|---|---|
| HASH DIGEST | 0x58 |
| ENCRYPTION KEY | 0x58 HD-SZ |
| NAME | 0x58 HD- |
| | SZ + EK-SZ |
| VDEF | 0x58 + HD- |
| | SZ + EK-SZ + |
| | Name-SZ |

When copying data from primary medium 301 to secondary medium 302, primary controller 310-1 dynamically calculates the CRC/hash/encryption as the data is moved. It then places in DA value 312 the results of that calculation. When copying data from secondary medium 302 to primary medium 301, primary controller 310-1 compares the results with DA value 312 read from secondary medium 302.

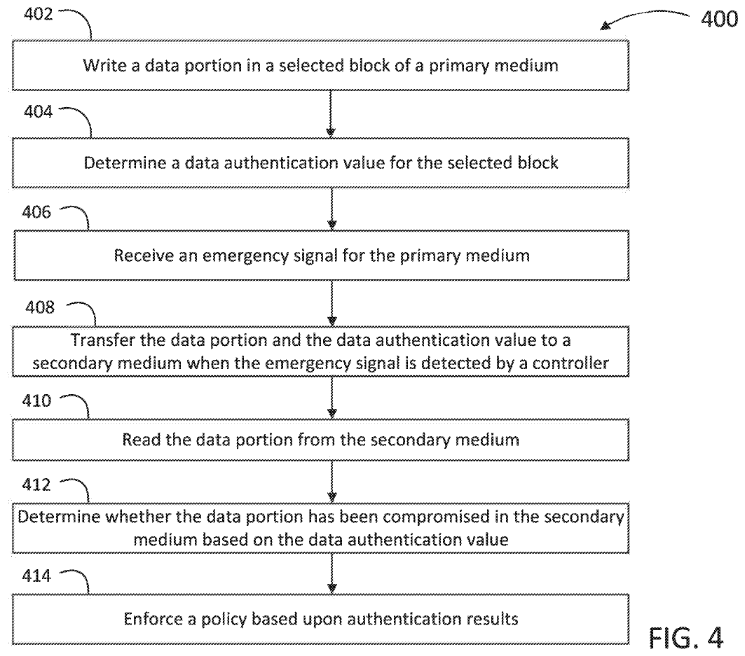

FIG. 4 is a flow chart illustrating steps in a method 400 for performing an emergency backup of a primary medium into a secondary medium for storage, according to some embodiments (e.g., primary medium 101 and secondary medium 102). Steps in method 400 may be performed by a controller of the primary medium that receives data from a processor in a computer architecture (e.g., controllers 110, processor 50, and system 10). The controller may transfer data from the primary medium to the secondary medium upon receipt of an emergency backup signal via a single-wire interface (e.g., emergency backup signal 140, interface 120). The controller and the primary medium may be included in a module having a local power source for emergency backup (e.g., LPS 151). In some embodiments, a tethered power source may be coupled to the module via a single-wire interface to the controller (e.g., TPS 150, interface 120). The controller may communicate with the tethered power source via a single-wire protocol, and determine the status and capabilities of the tethered power source before an emergency backup event occurs. Methods consistent with the present disclosure may include at least one, but not all, of the steps in method 400. Further, methods consistent with the present disclosure may include one or more of the steps in method 400 performed in a different order, or performed overlapping in time, or almost simultaneously.

Step 402 includes writing a data portion in a selected block of a primary medium.

Step 404 includes determining a DA value for the selected block (e.g., DA values 211, 212, 311, and 312). In some embodiments, step 404 includes hashing the data portion in the selected block using a hash code. In some embodiments, step 404 also includes encrypting the data portion with a private encryption key and a public encryption key pair, and storing the public encryption key in a key management system accessible to the controller or in the DA value. In some embodiments, step 404 includes storing the private encryption key local to primary controller (e.g., in a TPM). In some embodiments, step 404 includes storing a public key in a key management system accessible to the secondary controller, when the secondary controller is capable of decrypting the data. In some embodiments, step 404 also includes performing a cryptographically secured hash for the data portion (e.g., an unencrypted data block) to detect a tampering attempt on the data portion in the secondary medium. In some embodiments, step 404 also includes determining a second DA for a second block in the primary medium.

Step 406 includes receiving an emergency signal for the primary medium. In some embodiments, step 406 includes identifying at least one of a power loss event, or a volatile data loss event comprising a reset command, or a status check command, for the primary medium. In some embodiments, step 406 includes asserting the emergency backup signal.

In some embodiments, step 406 includes asserting the emergency backup signal by embedded logic to ensure predictable operation and latency. In some embodiments, step 406 may be performed by a management command to the embedded logic, which could be issued by software running on a processor (e.g., primary controller, or a processor outside of the backup module). In some embodiments, step 406 includes detecting an issue (e.g., a power failure, and the like) and taking immediate action. In some embodiments, step 406 may include waiting for an emergency signal to be asserted before any control structures are modified to trigger the data transfer from the primary medium to the secondary medium. Accordingly, in some embodiments step 406 includes ascertaining whether an emergency backup signal is legitimate (e.g., not a random electrical spike, or due to malware). In some embodiments, step 406 may include waiting for a time-window (e.g., about or less than 10 μs) that is long enough to disambiguate a random spike from a real signal.

Step 408 includes transferring the data portion and the DA value to a secondary medium when the emergency signal is detected by a controller. In some embodiments, step 408 includes providing power to the primary medium and the controller with an emergency power source for transferring the data portion and the DA value to the secondary medium. In some embodiments, step 408 includes transferring a second data portion in the second block and the second DA value to the secondary medium. In some embodiments, step 408 includes scheduling the transfer of the data portion from the primary medium to the secondary medium at a selected checkpoint along an application executed by a processor that has access to the primary medium. In some embodiments, step 408 includes selecting a checkpoint as a place in an executable script where the system automatically sends initiates a backup sequence or scenario for backup (e.g. during execution of a computationally intense calculation, or while writing a Word document, or writing a long e-mail, and the like). In some embodiments, step 408 includes sequentially storing the DA value adjacent to the data portion in the secondary medium. Checkpoints are managed backups of the primary media. In some embodiments, checkpoints may be triggered at any time, and are nearly identical to an emergency backup signal in terms of verifying the configuration and moving the data and can be initiated by a management command issued from a processor.

Step 410 includes reading the data portion from the secondary medium. In some embodiments, step 410 also includes reading the second data portion from the secondary medium.

Step 412 includes determining whether the data portion has been compromised in the secondary medium based on the DA value. In some embodiments, step 412 includes comparing a DA value determined with the controller (cf. step 404) with a DA value stored in the secondary medium. In some embodiments, step 412 includes performing a checksum on the DA value and comparing the checksum with a value obtained by the controller when the data portion is restored from the secondary medium. In some embodiments, step 412 includes determining whether the second data portion in the second block has been compromised in the secondary medium, based on the second DA value.

Step 414 includes enforcing a policy based upon the authentication results. In some embodiments, step 414 includes notifying a processor, with the controller, that the second data portion has been compromised in the secondary medium. In some embodiments, step 414 may include recovering compromised data, including quarantining the corrupted data and reconstructing corrupted data from other sources (e.g., checkpoint, periodic backup, and the like).

In the case of a failure of data authentication caused by system malfunction (e.g., secondary controller or secondary medium malfunction) data recovery can be performed by using robust erasure codes or ECC in addition to, or beyond strategies such as single-error correcting, double-error detecting (SECDED) codes used with DDR. For example, in some embodiments step 414 includes recovering multiple bits at a time, from a system malfunction.

### Hardware Overview

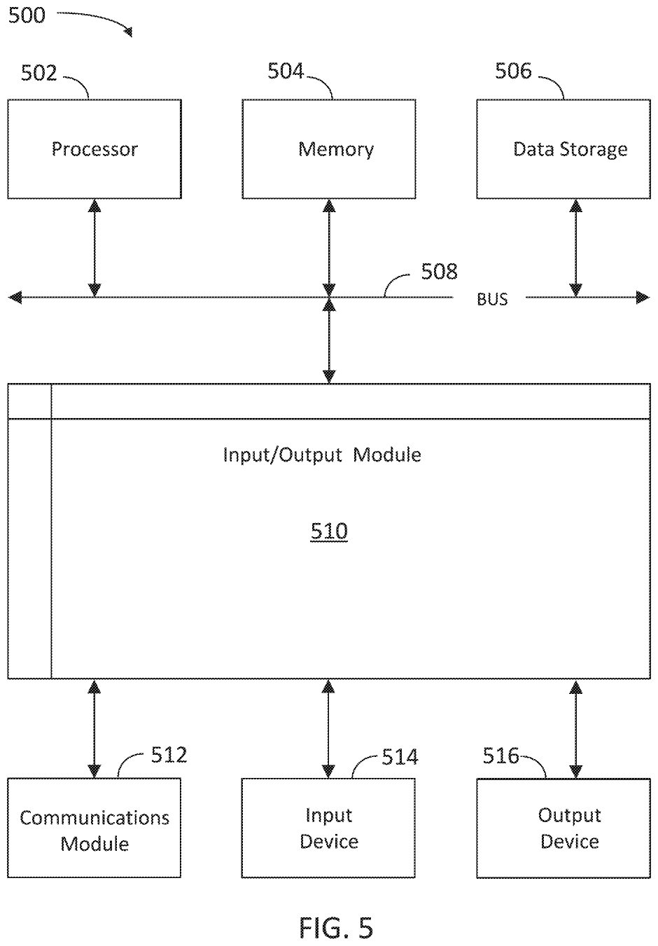

FIG. 5 is a block diagram illustrating an example computer system 500 with which the client and network device of FIGS. 1-2 and the method of FIG. 4 can be implemented. In certain aspects, the computer system 500 may be implemented using hardware or a combination of software and hardware, either in a dedicated network device, or integrated into another entity, or distributed across multiple entities. Computer system 500 (e.g., system 10) includes a bus 508 or other communication mechanism for communicating information, and a processor 502 (e.g., controllers 110) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a Graphics Processor Unit (GPU), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., primary medium 101 and secondary medium 102), such as a cache, a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, e.g., one or more modules of computer program instructions encoded on a computer readable medium for execution by, or to control the operation of, the computer system 500, and according to any method well-known to those of skill in the art, including, but not limited to, computer languages such as data-oriented languages (e.g., SQL, dBase), system languages (e.g., C, Objective-C, C++, Assembly). Memory 504 may also be used for storing temporary variable or other intermediate information during execution of instructions to be executed by processor 502.

Computer system 500 further includes a data storage 506 such as a magnetic disk or optical disk, coupled to bus 508 for storing information and instructions. Computer system 500 may be coupled via input/output module 510 to various devices. Input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 516 include display devices, such as an LCD (liquid crystal display) monitor, for displaying information to the user.

According to one aspect of the present disclosure, computer system 500 in response to processor 502 executes one or more sequences of one or more instructions contained in memory 504. Such instructions may be read into memory 504 from another machine-readable medium, such as data storage 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data network device, or that includes a middleware component, e.g., an application network device, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and network devices. A client and network device are generally remote from each other and typically interact through a communication network. The relationship of client and network device arises by virtue of computer programs running on the respective computers and having a client-network device relationship to each other. Computer system 500 can be, for example, and without limitation, a desktop computer, laptop computer, or tablet computer.

The term “machine-readable storage medium” or “computer readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage 506. Volatile media include dynamic memory, such as memory 504. Transmission media include coaxial cables, copper wire, and fiber optics, including the wires forming bus 508. Common forms of machine-readable media include, for example, floppy disk, a flexible disk, hard disk, magnetic tape, any other magnetic medium, a CD-ROM, DVD, any other optical medium, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Nothing disclosed herein is intended to be dedicated to the public regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

Multiple variations and modifications are possible and consistent with embodiments disclosed herein. Although certain illustrative embodiments have been shown and described here, a wide range of modifications, changes, and substitutions is contemplated in the foregoing disclosure. While the above description contains many specifics, these should not be construed as limitations on the scope of the embodiment, but rather as exemplifications of one or another preferred embodiment thereof. In some instances, some features of the present embodiment may be employed without a corresponding use of the other features. Accordingly, it is appropriate that the foregoing description be construed broadly and understood as being given by way of illustration and example only, the spirit and scope of the embodiment being limited only by the appended claims.

What is claimed is:

1. A computer-implemented method, comprising:
writing a data portion in a selected block of a primary medium;
determining a data authentication value for the selected block;
identifying an emergency signal for the primary medium;
transferring the data portion and the data authentication value to a secondary medium when the emergency signal is asserted by a controller;
reading the data portion from the secondary medium;
determining whether the data portion has been compromised in the secondary medium based on the data authentication value; and
notifying a processor, with the controller, that the data portion has been compromised in the secondary medium.

2. The computer-implemented method of claim 1, wherein identifying an emergency signal for the primary medium comprises identifying at least one of a power loss event, or a volatile data loss event comprising a reset command, for the primary medium.

3. The computer-implemented method of claim 1, further comprising providing power to the primary medium and the controller with an emergency power source, and signaling a catastrophic event via a single-wire communication protocol, for transferring the data portion and the data authentication value to the secondary medium.

4. The computer-implemented method of claim 1, wherein determining a data authentication value for the selected block comprises hashing the data portion in the selected block using a hash code.

5. The computer-implemented method of claim 1, wherein determining a data authentication value for the selected block comprises:
encrypting the data portion with a private encryption key and a public encryption key; and
storing the public encryption key in a key management system accessible to the controller.

6. The computer-implemented method of claim 1, wherein determining a data authentication value for the selected block comprises performing a cryptographically-secured hash for the data portion.

7. The computer-implemented method of claim 1, wherein determining whether the data portion has been compromised in the secondary medium comprises comparing a data authentication value recovered with the controller with a data authentication value stored in the secondary medium.

8. The computer-implemented method of claim 1, wherein determining whether the data portion has been compromised in the secondary medium based on the data authentication value comprises performing a checksum on the data authentication value and comparing the checksum with a value obtained by the controller when the data portion is restored from the secondary medium.

9. The computer-implemented method of claim 1, further comprising:
determining a second data authentication value for a second block in the primary medium;
transferring a second data portion in the second block and the second data authentication value from to the secondary medium;
determining whether a second data portion in the second block has been compromised in the secondary medium, based on the second data authentication value; and
notifying a processor, with the controller, that the second data portion has been compromised in the secondary medium.

10. The computer-implemented method of claim 1, further comprising:
determining a second data authentication value for a second block in a second primary medium that is separate from the primary medium;
transferring a second data portion in the second block and the second data authentication value to the secondary medium;
reading the second data portion from the secondary medium;
determining whether the second data portion has been compromised in the secondary medium based on the second data authentication value; and
notifying a second processor, with a second controller, that the second data portion has been compromised in the secondary medium.

11. A system, comprising:
a first module, comprising:
a controller, coupled to a primary medium including data provided by a processor, the controller configured to:
select a block of the primary medium that includes a data portion;
determine a data authentication value for the block;
identify an emergency signal for the primary medium;
assert the emergency signal;
transfer the data portion and the data authentication value to a secondary medium;
read the data portion from the secondary medium;
determine whether the data portion has been compromised in the secondary medium based on the data authentication value; and
notify a processor that the data portion has been compromised in the secondary medium.

12. The system of claim 11, wherein the first module comprises the primary medium, and the primary medium comprises a volatile memory storage.

13. The system of claim 11, wherein the first module comprises the secondary medium, and the secondary medium comprises a non-volatile storage, further wherein the controller determines whether the data portion has been compromised in the secondary medium based on the data authentication value recovered from the secondary medium.

14. The system of claim 11, further comprising a second module that includes a second data portion from a second primary medium separate from the primary medium, wherein the controller is further configured to determine a second data authentication value for the second data portion, and to transfer the second data authentication value and the second data portion to the secondary medium when the emergency signal is asserted.

15. The system of claim 11, wherein the controller is further configured to store a copy of the data authentication value for the block in a non-volatile memory separate from the secondary medium.

16. The system of claim 11, wherein to determine a data authentication value for the block the controller is further configured to hash the data portion in the secondary medium using a hash code, and to recover the hash code when the data portion is read from the secondary medium.

17. A device, comprising:
a controller, coupled to a primary medium and a secondary medium, the controller configured to:
separate the primary medium into multiple blocks;
select a block from the multiple blocks that includes a data portion;
determine a data authentication value for the block;
assert an emergency signal for the primary medium;
transfer the data portion and the data authentication value to the secondary medium;
read the data portion from the secondary medium;
determine whether the data portion has been compromised in the secondary medium, based on the data authentication value; and
notify a processor that the data portion has been compromised in the secondary medium.

18. The device of claim 17, further comprising a first module that includes the primary medium, wherein the primary medium comprises a volatile memory.

19. The device of claim 17, further comprising a first module that includes the secondary medium, and the secondary medium comprises a non-volatile storage.

20. The device of claim 17, further comprising a second module that includes a second data portion from a second primary medium separate from the primary medium, wherein the controller is further configured to determine a second data authentication value for the second data portion, and to transfer the second data authentication value and the second data portion to the secondary medium when the emergency signal is asserted.
